(19) United States
(12) Patent Application Publication
(10) Pub. No.: US 2026/0233683 A1
(43) Pub. Date: Aug. 13, 2026

(54) STORAGE BOXES FOR COUPLING WITH A LATCH MOUNTED TO A VEHICLE

(71) Applicant: Toyota Motor Engineering & Manufacturing North America, Inc., Plano, TX (US)

(72) Inventors: Aaron R. Steinhilb, Milan, MI (US); Jeremiah T. Hammer, Ann Arbor, MI (US); Timothy J. Woychowski, Fenton, MI (US); Haley L. Grantham, Saline, MI (US); Troy N. Grantham, Saline, MI (US); Joseph C. Taylor, Ypsilanti, MI (US); Phouvadol P. Khouphongsy, Saline, MI (US)

(73) Assignees: Toyota Motor Engineering & Manufacturing North America, Inc., Plano, TX (US); Toyota Jidosha Kabushiki Kaisha, Aichi-Ken (JP)

(21) Appl. No.: 19/048,084

(22) Filed: Feb. 7, 2025

(51) Int. Cl. B60R 9/06

(52) U.S. Cl. CPC B60R 9/065

(57) ABSTRACT

A storage box for coupling with a latch mounted to a vehicle includes a container having a bottom surface configured to face a floor surface of the vehicle and a hook mounted to the container adjacent the bottom surface and defining a channel configured to engage the latch to couple the container to the vehicle. The hook is rotatable between a stowed position in which the hook is at least flush with the bottom surface of the container and a locked position in which the hook protrudes from the bottom surface for engaging the latch.

### TECHNICAL FIELD

The present specification generally relates to storage boxes for vehicles and, more specifically, storage boxes for coupling with a latch of a vehicle.

### BACKGROUND

The use of vehicles on off-road trails is a hobby for many vehicle operators. The remote nature duration of off-roading often requires the vehicle operator to pack the vehicle with items for the various situations they might experience and for the duration of the trip. The items may include off road gear, tools, food, clothing, camping equipment, and other items. The vehicle operators may desire to package the items within a storage container to organize the items and to reduce movement of the items within the vehicle. While these storage containers may secure the items within the containers, the storage containers themselves are often not secured to the vehicle and may move around within the vehicle during operation of the vehicle.

Accordingly, a need exists for storage boxes for coupling with a latch of a vehicle.

### SUMMARY

In one embodiment, a storage box for coupling with a latch mounted to a vehicle may include a container having a bottom surface configured to face a floor surface of the vehicle and a hook mounted to the container adjacent the bottom surface and defining a channel configured to engage the latch to couple the container to the vehicle. The hook is rotatable between a stowed position in which the hook is at least flush with the bottom surface of the container and a locked position in which the hook protrudes from the bottom surface for engaging the latch.

In another embodiment, storage box system for a vehicle may include a floor surface, a latch disposed adjacent the floor surface and configured to be mounted to the vehicle. The storage box system may further include a storage box. The storage box may include a container having a bottom surface facing the floor surface and a hook mounted to the container adjacent the bottom surface and defining a channel that engages the latch to couple the container to the vehicle. The hook is rotatable between a stowed position in which the hook is at least flush with the bottom surface of the container and a locked position in which the hook protrudes from the bottom surface and engages the latch.

In yet another embodiment, a storage box for coupling with a latch mounted to a vehicle may include a container having a bottom surface configured to face a floor surface of the vehicle and a hook mounted to the container adjacent the bottom surface and defining a channel configured to engage the latch to couple the container to the vehicle. The hook is rotatable about an axis between a stowed position in which the hook is at least flush with the bottom surface of the container and a locked position in which the hook protrudes from the bottom surface for engaging the latch. The hook includes a cam surface partially defining the channel and facing the bottom surface of the container in the locked position. The cam surface is configured to engage the latch disposed in the channel in the locked position. The cam surface has an arcuate configuration and extends between a first end spaced a first distance from the axis and a second end spaced a second distance from the axis and less than the first distance. The hook is configured to move the cam surface along the latch from the first end toward the second end as the hook rotates from the stowed position to the locked position and correspondingly moves the container toward the floor surface. The storage box may include a handle coupled to the hook and movable between a first position and a second position that drives rotation of the hook between the stowed position and the locked position, respectively and a box latch mounted to the container adjacent a top surface, opposite the bottom surface, and configured to couple a second storage box thereto.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts a top plan view of a vehicle and a plurality of storage box systems, according to one or more embodiments shown and described herein;

FIG. 2 schematically depicts a perspective view of one of a storage box system having latches adjacent a floor surface and a storage box spaced from the floor surface and having hooks, according to one or more embodiments shown and described herein;

FIG. 3 schematically depicts a side elevational view of the storage box system of FIG. 2, with the hooks disposed in a stowed position and with the storage box disposed on the floor surface, according to one or more embodiments shown and described herein;

FIG. 4 schematically depicts a perspective view of the storage box system of FIG. 2, with the storage box disposed on the floor surface and with the hooks engaging the latches in a locked position, according to one or more embodiments shown and described herein;

FIG. 5 schematically depicts a perspective view of the storage box system of FIG. 2, with the storage box disposed on the floor surface and with a second storage box disposed on a top surface of the storage box, according to one or more embodiments shown and described herein;

FIG. 6 schematically depicts a partial cross-sectional view of a portion of the storage box system of FIG. 2, showing a handle and a transmission assembly coupled to the hook with the hook is disposed in the stowed position, according to one or more embodiments shown and described herein;

FIG. 7 schematically depicts a partial cross-sectional view of a portion of the storage box system of FIG. 2, showing the handle and the transmission assembly coupled to the hook with the hook disposed in the locked position, according to one or more embodiments shown and described herein;

FIG. 8 schematically depicts a cross-sectional view of a portion of the storage box system of FIG. 2, showing the hook disposed in the stowed position, according to one or more embodiments shown and described herein;

FIG. 9 schematically depicts a cross-sectional view of a portion of the storage box system of FIG. 2, showing the hook disposed between the stowed position and locked position, according to one or more embodiments shown and described herein;

FIG. 10 schematically depicts a cross-sectional view of a portion of the storage box system of FIG. 2, showing the hook disposed in the locked position, according to one or more embodiments shown and described herein; and

FIG. 11 schematically depicts a partial cross-sectional view of the hook of FIG. 2, showing a cam surface and a detent, according to one or more embodiments shown and described herein.

### DETAILED DESCRIPTION

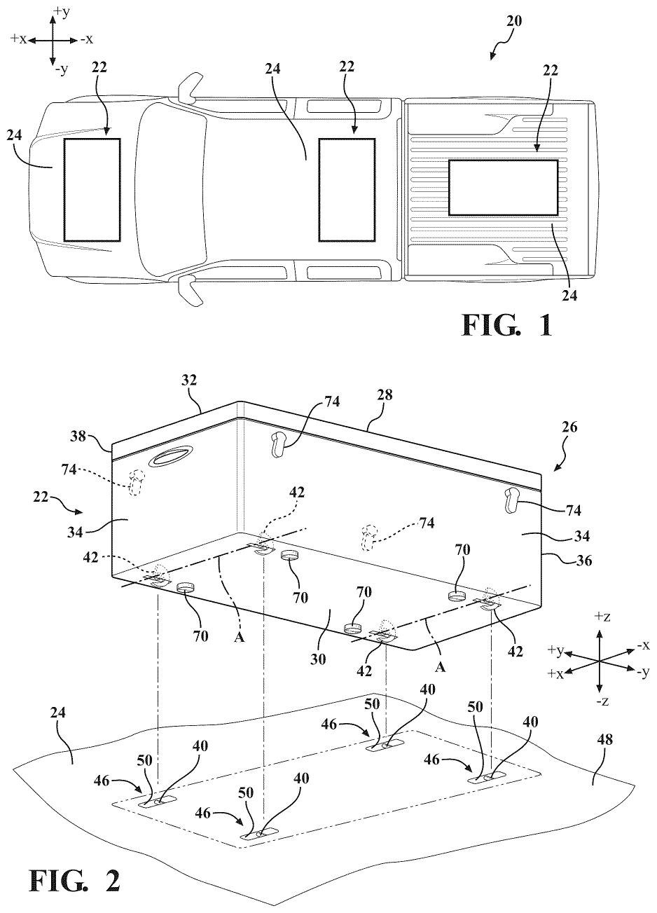

FIGS. 1 and 2 generally depicts a storage box system for a vehicle. The storage box system may include a floor surface, a latch disposed adjacent the floor surface and configured to be mounted to the vehicle. The storage box system may further include a storage box. The storage box may include a container having a bottom surface facing the floor surface and a hook mounted to the container adjacent the bottom surface and defining a channel that engages the latch to couple the container to the vehicle. The hook is rotatable between a stowed position in which the hook is at least flush with the bottom surface of the container and a locked position in which the hook protrudes from the bottom surface and engages the latch.

Previous ways of storing items within a vehicle involved placing a storage container within the vehicle and filling the storage container with the items. However, the storage containers themselves are often not secured to the vehicle and may move around within the vehicle during operation of the vehicle. The embodiments described herein provide the storage box configured to be coupled to the vehicle. The latch is mounted vehicle adjacent the floor surface. The hook of the storage box engages the latch in a locked position and secures the storage box relative to the vehicle. Furthermore, the movement of the hook to the stowed position allows the storage box to be removed for the vehicle when its use is not necessary within the vehicle, freeing up space within the vehicle that may be occupied by other people, objects, etc. Various embodiments and benefits of the storage box system and the storage box will be described in more detail herein.

As used herein, the term “vehicle longitudinal direction” refers to the forward-rearward direction of the vehicle (i.e., in the +/−X direction of the coordinate axes depicted in FIG. 1). The term “vehicle lateral direction” refers to the cross-vehicle direction (i.e., in the +/−Y direction of the coordinate axes depicted in FIG. 1), and is transverse to the vehicle longitudinal direction. The term “vehicle vertical direction” refers to the upward-downward direction of the vehicle (i.e., in the +/−Z direction of the coordinate axes depicted in FIG. 1). As used herein, “upper” and “above” are defined as the positive Z direction of the coordinate axes shown in the drawings. “Lower” and “below” are defined as the negative Z direction of the coordinate axes shown in the drawings.

Referring now to FIG. 1, a vehicle 20 is provided with a storage box system 22, in accordance with one or more embodiments of the present disclosure. The storage box system 22 is used for securing items within the vehicle 20, which may otherwise move within or be expelled from the vehicle 20 during operation of the vehicle 20. FIG. 1 is an embodiment in which the vehicle 20 is configured as a pickup truck and demonstrates three potential locations for the storage box system 22 within the pickup truck: a bed of the pickup truck, a passenger cabin of the pickup truck, and a front trunk (“frunk”) of the pickup truck. The storage box system 22 may be used in one or more of the locations shown in FIG. 1. Furthermore, the locations shown in FIG. 1 are merely demonstrative and vary in position, size, number, etc. Moreover, while the vehicle 20 shown in FIG. 1 is configured as a pickup truck, the storage box system 22 may be used in any configuration of a vehicle (e.g., a passenger car, a van, a sport-utility vehicle, a crossover vehicle, airplane, boat, etc.) and may be used in any suitable location within the vehicle 20, including configuration specific locations (e.g., in the trunk of a passenger vehicle).

FIG. 2 is a schematic perspective view of an embodiment of the storage box system 22. The storage box system 22 includes a floor surface 24, which may partially form the bed, the passenger cabin, the frunk, etc. The storage box system 22 further includes a storage box 26. The storage box 26 is spaced from the floor surface 24 in FIG. 2 to illustrate that the storage box 26 may be removed from the vehicle 20. More specifically, the storage box 26 may be selectively placed on the floor surface 24 and moved between an engaged position and a disengaged position. In the engaged position, the storage box 26 is mounted to the vehicle 20 and movement of the storage box 26 with respect to the floor surface 24 is inhibited. In the disengaged position, the storage box 26 is disengaged from the floor surface 24 and movement of the storage box 26 with respect to the floor surface is permitted. The storage box system allows a user to utilize the storage box 26 in the vehicle 20 when desired and to remove the storage box 26 from the vehicle 20 and regain the space occupied by the storage box 26 when the user does not require use of the storage box 26.

The storage box 26 includes a container 28 having a bottom surface 30 that faces the floor surface 24 when the container 28 is positioned on the floor surface 24. The storage box 26 may further include a top surface 32 disposed opposite the bottom surface 30 and one or more side surfaces 34 extending between the bottom surface 30 and the top surface 32. The container 28 shown in FIG. 2 is configured as a rectangular prism. Therefore, the container 28 includes four side surfaces 34. However, the container 28 may have any suitable shape and configuration and therefore may have any number of side surfaces 34.

Although not shown, the container 28 may define an interior within which items may be stored. The container 28 shown in FIG. 2 includes a housing 36 forming a majority of the container 28 and a cover 38 that may be moved to provide access into the interior. The top surface 32 of the container 28 may be at least partially disposed on the cover 38. It is to be appreciated that the container 28 may have other configurations for storing the items. For example, the container 28 may include drawers that are slidably disposed within the container 28 for storing the items therein. In another example, the container 28 is insulated for maintaining a temperature of air and items therein. In yet another example, the container 28 may include a refrigeration unit for cooling the interior of the container 28 (e.g., for food storage).

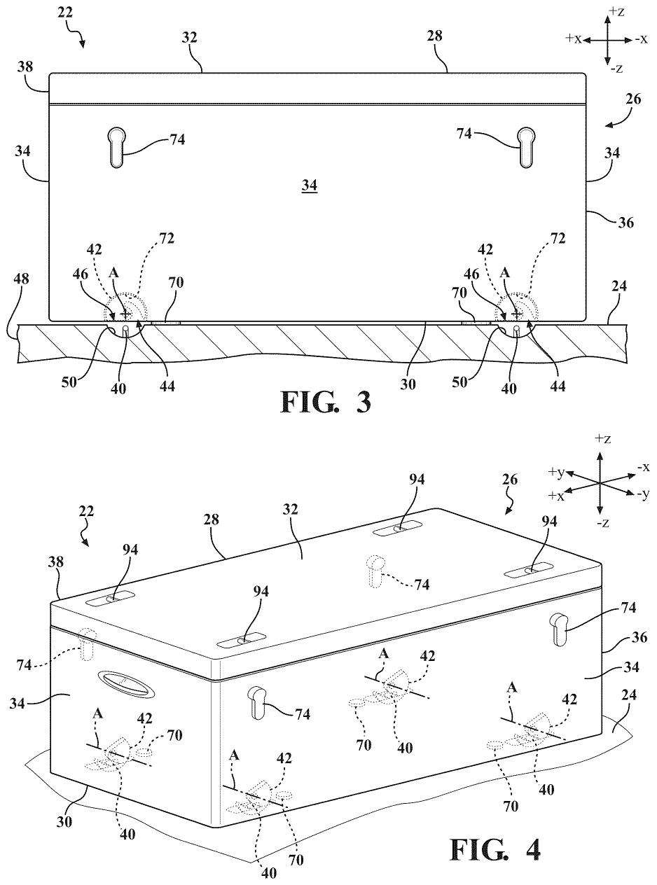

The storage box system 22 further includes a latch 40 disposed adjacent the floor surface 24 and configured to be mounted to the vehicle 20. In a corresponding manner, the storage box 26 includes a hook 42 mounted to the container 28 adjacent the bottom surface 30 and defining a channel 44 that engages the latch 40 to couple the container 28 to the vehicle 20, as shown in FIGS. 3 and 6-10. The hook 42 is rotatable about an axis A between a stowed position in which the hook 42 is at least flush with the bottom surface 30 of the container 28 (see FIGS. 3, 6, and 8) and a locked position in which the hook 42 protrudes from the bottom surface 30 and engages the latch 40 (see FIGS. 4, 7, and 10). In the stowed position, the storage box 26 is in the disengaged position and may be moved independent of the vehicle 20. Moreover, in the stowed position, the bottom surface 30 of the storage box 26 may be directly placed on a surface without contacting the hook 42 with the surface (as the hook 42 is at least flush with the bottom surface 30). As such, the storage box 26 is a versatile object in the stowed position. In the locked position, the storage box 26 is in the engaged position to secure the storage box 26 to the vehicle 20 by the engagement of the hook 42 with the latch 40. Therefore, the storage box 26 (and the items within the storage box 26) is retained relative to the vehicle 20.

The storage box system 22 may include more than one of the latch 40 and more than one of the hook 42. In the embodiment shown in FIG. 2, the storage box system 22 includes four latches 40 mounted to the vehicle 20 and four hooks 42 mounted to the container 28. Each of the hooks 42 are positioned along the bottom surface 30 of the container 28 and individually disposed adjacent a corner of the container 28 (e.g., four corners of the container 28 configured as a rectangular prism). The latches 40 are positioned relative to one another along the floor surface 24 in a configuration that mirrors the positioning of the hooks 42 along the bottom surface 30 of the container 28. As such, the hooks 42 are individually aligned with the latches 40 when the storage box 26 is properly positioned on the floor surface 24. It is to be appreciated that storage box system 22 may include any number of latches 40 and any number of hooks 42, each of which may be positioned in any configuration that is suitable for mounting of the storage box 26 to the vehicle 20.

The floor surface 24 may define at least one aperture 46, with the aperture 46 corresponding with the latch 40. The number of apertures 46 may be equal to the number of latches 40 (e.g., four apertures 46 and four latches 40 as shown in FIG. 2). As such, the latches 40 may be individually aligned with the apertures 46 and disposed beneath the floor surface 24. In one embodiment, the floor surface 24 may be disposed upon a floor pan 48 that is mounted to the vehicle 20, as shown in FIG. 3. The floor pan 48 may define a recess 50 at each of the latches 40 with the apertures 46 individually opening into the recesses 50. The latches 40 may be mounted to the floor pan 48.

For simplicity, the description below will refer to the interaction between one of the latches 40 and one of the hooks 42 as the hook 42 moves between the stowed position and the locket position. However, the teachings below may be applied to any of the latches 40 and any of the hooks 42.

The latch 40 may extend horizontally and may have a substantially cylindrical configuration. More specifically, at least a portion of the latch 40 may extend horizontally and have the substantially cylindrical configuration. In the embodiment shown in FIG. 6-10, the latch 40 includes an engagement portion 52 extending horizontally and a pair of legs 54 extending vertically from the engagement portion 52 toward the floor pan 48, with the pair of legs 54 mounted to the vehicle 20. Accordingly, the engagement portion 52 and the pair of legs 54 form a substantially inverted U-shape. The engagement portion 52 of the latch 40 is configured to be received within the channel 44 of the hook 42. At least the engagement portion 52 has the substantially cylindrical configuration. It is to be appreciated that any suitable portion of the latch 40 may have the substantially cylindrical configuration. Moreover, the latch 40 may have any suitable shape and configuration for mounting to the vehicle 20 and coupling with the hook 42.

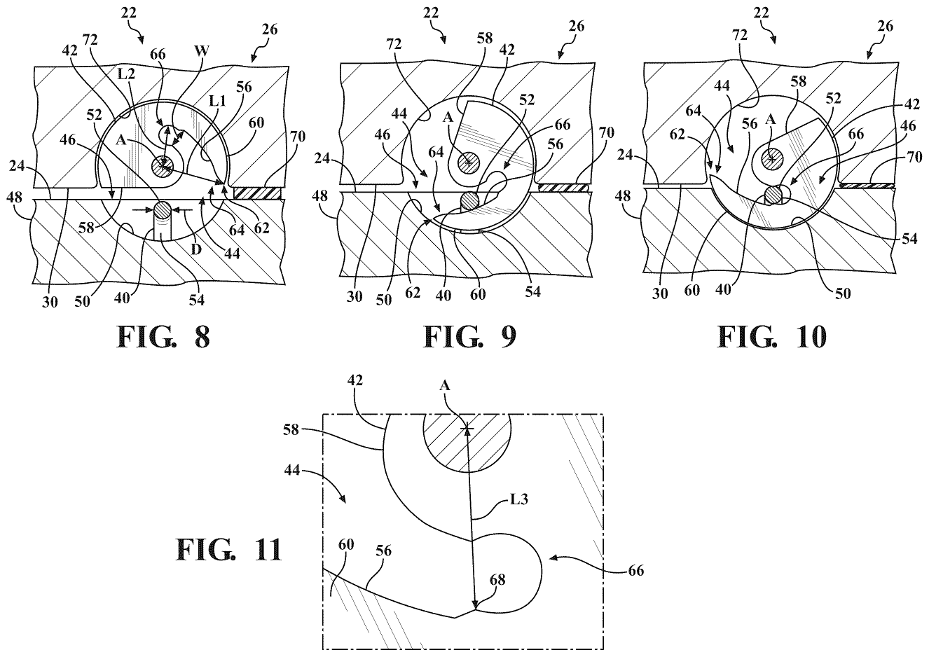

As shown in FIG. 8, the latch 40 may have a diameter D. More specifically, the engagement portion 52 of the latch 40 may have the diameter D. Moreover, the channel 44 of the hook 42 may have a minimum width W. The minimum width W is greater than or equal to the diameter D. As such, the engagement portion 52 of the latch 40 sized to move within and be received by the channel 44 of the hook 42.

As shown in FIGS. 8-10, the hook 42 may include a cam surface 56 partially defining the channel 44 and facing the bottom surface 30 of the container 28 in the locked position. The cam surface 56 may be configured to engage the latch 40 disposed in the channel 44 in the locked position. More specifically, the hook 42 has a body 58 that is coupled to the container 28 by a pin, an axle, a stud, a bolt, etc. at the axis A and is thus rotatable about the axis A. The hook 42 further includes an arm 60 extending from the body 58 to a distal end 62. The body 58 and the arm 60 may be integrally formed. Alternatively, the body 58 and the arm 60 may be formed separately and joined to one another. The channel 44 is defined between the body 58 and the arm 60. The cam surface 56 is disposed on the arm 60 and faces the axis A. The arm 60 extends below the latch 40 as the hook 42 rotates from the stowed position to the locked position. The disposition of arm 60 below the latch 40 causes the cam surface 56 to engage the latch 40 when the storage box 26 moves in a vertical direction, thereby retaining the storage box 26 to the vehicle 20 in the vertical direction. The vertical direction corresponds with the vehicle vertical direction Z in the embodiment shown in the FIGS. However, vertical direction may vary from the vehicle vertical direction Z in other embodiments. As shown in FIGS. 6-10, the arm 60 may be sized to move within the recess 50 between the latch 40 and the floor such that the latch 40 extends around the latch 40.

As shown in FIGS. 8-10, the cam surface 56 extends between a first end 64 and a second end 66. The first end 64 of the cam surface 56 may be disposed adjacent the distal end 62 of the arm 60 and the second end 66 of the cam surface 56 may be disposed at the interface of the body 58 and the arm 60. The hook 42 may be configured to move the cam surface 56 along the latch 40 from the first end 64 toward the second end 66 as the hook 42 rotates from the stowed position to the locked position and correspondingly move the container 28 toward the floor surface 24. More specifically, as shown FIGS. 8-10, rotation of the hook 42 from the stowed position to the locked position causes the arm 60 to move toward, and then under, the latch 40. As such, as the distal end 62 of the arm 60 passes by the latch 40, the cam surface 56 comes into engagement with the latch 40 adjacent the first end 64. Continued movement of the hook 42 toward the locked position causes the cam surface 56 to slide along the latch 40 toward the second end 66, with the hook 42 reaching the locked position when the latch 40 is disposed adjacent the second end 66 of the cam surface 56.

As shown in FIG. 8, the first end 64 of the cam surface 56 may be spaced a first distance L1 from the axis A and the second end 66 of the cam surface 56 may be spaced a second distance L2 from the axis A. The second distance L2 may be less than the first distance L1. As such, the second end 66 of the cam surface 56 may be closer to the axis A than the first end 64, causing the container 28 and the latch 40 to progressively move toward one another as the hook 42 rotates from the stowed position to the locked position. In doing so, the container 28 becomes tightened against the floor surface 24 to reduce movement between the storage box 26 and the vehicle 20 in the locked position.

The cam surface 56 may have an arcuate configuration. The arcuate configuration may facilitate a smooth transition of the latch 40 along the cam surface 56 as the hook 42 moves between the stowed position and the locked position. As shown in FIG. 8, the arcuate configuration of the cam surface 56 may be non-concentric with axis A, allowing for the transition between the first distance L1 and the second distance L2. It is to be appreciated that the cam surface 56 may have any suitable configuration, such as a linear configuration, a composition of angularly-arranged linear configurations, a composition of arcuate configurations, combinations of the aforementioned arrangements, etc.

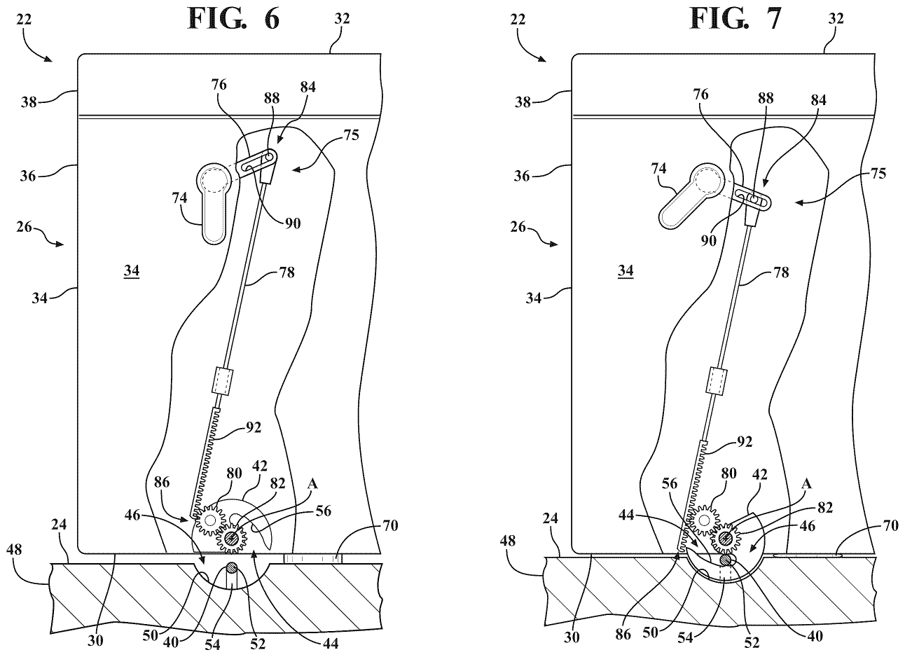

The channel 44 may open toward the bottom surface 30 of the container 28 in the locked position to retain the latch 40 therein, as shown in FIGS. 7 and 10. Said differently, the distal end 62 of the arm 60 wraps around the latch 40 and extends up toward the bottom surface 30 of the container 28 in the locked position, thereby positioning to channel 44 opening toward the bottom surface 30 of the container 28. As such, in the locked position the arm 60 partially engages opposing sides of the latch 40 in a horizontal direction, thereby retaining movement of the storage box 26 in the horizontal direction and preventing inadvertent disengagement of the hook 42 from the latch 40. In the embodiment shown in the Figures, the horizontal direction corresponds with the vehicle longitudinal direction X and/or the vehicle lateral direction Y. However, the horizontal direction may vary from the vehicle longitudinal direction X and/or the vehicle lateral direction Y in other embodiments.

As shown in FIG. 11, the hook 42 may include a detent 68 extending into the channel 44 from the cam surface 56 between the first end 64 and the second end 66 for inhibiting movement of hook 42 from the locked position to the stowed position when the cam surface 56 engages the latch 40. The detent 68 is configured as a wall that the latch 40 must move over when sliding along the cam surface 56 between the stowed position and the locked position. The detent 68 may be spaced a third distance L3 from the axis A, with the third distance L3 less than the first distance L1 and/or the second distance L2 (shown in FIG. 8). To move the latch 40 over the detent 68, additional torque is exerted on the rotation of the hook 42 in order to move and/or deform one or more components of the storage box 26 or the latch 40 in the vertical direction to facilitate movement of the latch 40 over the detent 68. Therefore, when the latch 40 is disposed at the second end 66 of the cam surface 56 in the locked position, the latch 40 engages the detent 68 when the hook 42 is rotated toward the stowed position. The torque to rotate the hook 42 over the detent 68 may be greater than torque exerted on the hook 42 through operation of the vehicle 20 (e.g., rotation of the hook 42 caused by vibrations and movement of the storage box 26 during operation of the vehicle 20). As such, the torque to move the latch 40 over the detent 68 may be exerted by the intentional rotation of the hook 42 by a user. Therefore, the detent 68 may prevent inadvertent movement of the hook 42 from the locked position to the stowed position, which would disconnect the storage box 26 from the vehicle 20 and cause inadvertent movement of the storage box 26 relative to the vehicle 20.

The storage box 26 may further include at least one foot 70 disposed along and extending away from the bottom surface 30 and configured to engage the floor surface 24 of the vehicle 20. In the embodiment shown in FIGS. 2 and 4, the storage box 26 includes four feet 70 that are individually disposed adjacent each of the four hooks 42. However, any number of feet 70 may be utilized. For simplicity, the description below will refer to one of the four feet 70. However, the teachings below may be applied to any of the feet 70.

The foot 70 may be configured to exert a bias between the container 28 and the floor surface 24 as the container 28 moves toward the floor surface 24 when the hook 42 moves from the stowed position to the locked position and engages the latch 40. More specifically, the foot 70 may compress as the hook 42 moves from the stowed position to the locked position and engages the latch 40 (as illustrated between FIGS. 6-7 and between FIGS. 8-10). The compression of the foot 70 may in-turn exert the bias between the container 28 and the floor surface 24. The bias exerted between the container 28 and the floor surface 24 tries to move the container 28 away from the floor surface 24 in the vertical direction. As such, the cam surface 56 of the hooks 42 engages and exerts a force on the latch 40, which reduces movement therebetween during operation of the vehicle 20 that can be perceived as noise, vibration, and/or harshness (“NVH”). The foot 70 is comprised of an elastomer, such as thermoplastic elastomer (“TPE”), silicone, butyl, etc. However, the foot 70 may have any suitable configuration for exerting the bias between container 28 and the floor surface 24, such as a spring, a fluid bladder, etc.

As shown in FIG. 3, the container 28 may define at least one cavity 72 that extends inwardly from the bottom surface 30. More specifically, the container 28 includes four cavities 72 that are individually positioned adjacent each of the four hooks 42. The hooks 42 may be individually mounted to the container 28 within the cavities 72. The hooks 42 may be entirely disposed within the cavities 72 in the stowed position. As such, the bottom surface 30 of the storage box 26 may be placed on any surface in the stowed position without the hooks 42 contacting the surface, which can cause wear to the hooks 42 and can produce uneven contact and support on the container 28. The hooks 42 may protrude out of the cavities 72 in the locked position to engage the latches 40.

While number of cavities 72 is equal to the number of hooks 42 in the embodiment shown in the Figures, any number of cavities 72 may be utilized. For example, more than one of the hooks 42 may be disposed within one cavity 72 (e.g., four hooks 42 disposed within a single, large cavity 72 positioned along the bottom surface 30 of the container 28). Furthermore, in other embodiments the hooks 42 be disposed along and mounted to the side surfaces 34 of the container 28 such that the hooks 42 are at least flush with the bottom surface 30 in the stowed position.

As shown in FIGS. 2-4, the storage box 26 may further include a handle 74 coupled to the hook 42 and movable between a first position and a second position that drives rotation of the hook 42 between the stowed position and the locked position, respectively. More specifically, as shown in FIGS. 2 and 4, the storage box 26 includes four handles 74 individually coupled with the four hooks 42. Each of the handles 74 are movable between the first position and the second position and configured to individually drive rotation of each of the respective hooks 42. As shown in FIGS. 6 and 7, the storage box 26 may further include four transmission assemblies 75 that are each individually couple to the handles 74 and individually coupled to the hooks 42 that correspond to the handles 74. The transmission assemblies 75 is configured to the transmit the movement of the handles 74 to the hooks 42 for rotating the hooks 42. For simplicity, the description below will refer to the interaction between one of the handles 74, one of the transmission assemblies 75, and one of the hooks 42. However, the teachings below may be applied to any of the handles 74, the transmission assemblies 75, and the hooks 42.

With reference to FIGS. 6 and 7, the handle 74 is rotatably mounted to one of the side surfaces 34 of the box. The handle 74 is disposed in a substantially vertical orientation in the first position and an at least partially horizontal orientation in the second position. However, the handle 74 may be disposed in any suitable orientation for the first position and the second position. Moreover, while the handle 74 is shown to rotate in FIGS. 6 and 7, the handle 74 may be configured to translate, pivot, or move in any other suitable manner between the first position and the second position.

The transmission assembly 75 includes a slide linkage 76, a translating linkage 78, an idler gear 80, and a pinion gear 82. The slide linkage 76 is mounted to, and rotatable with, the handle 74. The pinion gear 82 is mounted to and rotatable with, the hook 42. The idler gear 80 is rotatably meshed with the pinion gear 82. The translating linkage 78 extends between a first link end 84 adjacent the handle 74 and a second link end 86 adjacent the hook 42. The translating linkage 78 includes a pin 88 at the first link end 84. The slide linkage 76 defines a pathway 90 that receives the pin 88 of the translating linkage 78. The pin 88 is slidable within the pathway 90. The translating linkage 78 further includes a rack gear 92 at the second link end 86. The rack gear 92 is meshed with the idler gear 80. When the user rotates the handle 74 between the first position and the second position, the slide linkage 76 rotates with the handle 74. The pin 88 of the translating linkage 78 slides within the pathway 90 of the slide linkage 76, causing the translating linkage 78 to move in the vertical direction. The movement of the translating linkage 78 causes the rack gear 92 to translating, which in-turn rotates the idler gear 80. The rotation of the idler gear 80 rotates the pinion gear 82, which rotates the hook 42 between the stowed position and the locked position. It is to be appreciated that the transmission assembly 75 may include any suitable components (e.g., linkages, gears, belts, pulleys, etc.) for transmitting movement from the handle 74 to the hook 42.

While the four handles 74 are shown in FIGS. 2 and 4 to individually correspond with the four hooks 42, any number of the hooks 42 may be coupled to one of the handles 74. For example, the four hooks 42 may be coupled to a single transmission assembly that is coupled to a single handle. In such an example, rotation of the single handle between the first position and the second position may drive rotation of each of the four hooks 42 between the stowed position and the locked position, respectively. Furthermore, in other embodiments, the hooks 42 may be coupled to one or more actuators (e.g., an electric actuator, a pneumatic actuator, a hydraulic actuator, etc.) that drive the rotation of the hooks 42. It is to be appreciated that the hooks 42 may be driven between the stowed position and locked position in any suitable manner.

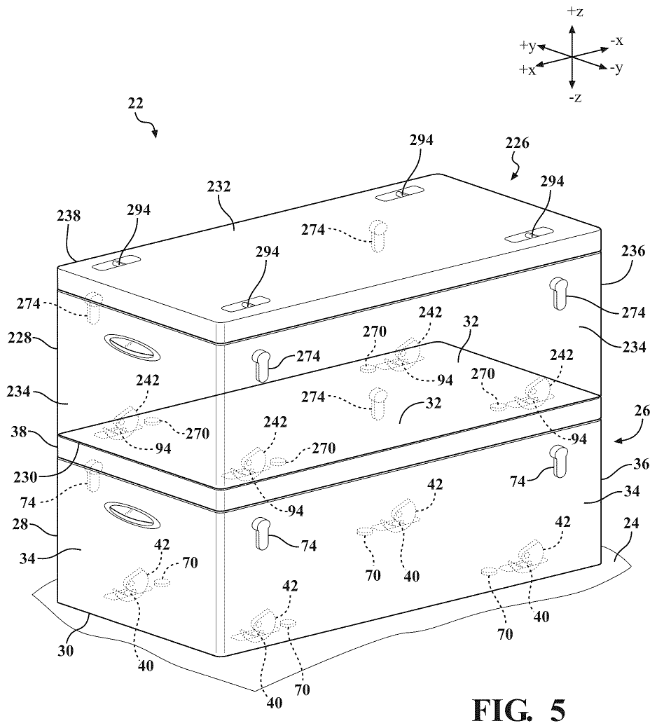

Referring to FIG. 5, the storage box 26 may further include at least one box latch 94 mounted to the container 28 adjacent the top surface 32, opposite the bottom surface 30, and configured to couple a second storage box 226 to the storage box 26. More specifically, as shown in FIGS. 4 and 5, the storage box 26 may include four box latches 94 mounted to the container 28 adjacent the top surface 32. The container 28 may define four recesses individually corresponding with the four box latches 94. The box latches 94 may be individually disposed within the recesses such that the box latches 94 are positioned beneath the top surface 32 of the container 28.

As shown in FIG. 5, the second storage box 226 may be identical in configuration to the storage box 26 described above. As such, the description of the storage box 26 above is directly applicable to the second storage box 226. Accordingly, the second storage box 226 may include at least a container 228, a bottom surface 230, a top surface 232, side surfaces 234, a housing 236, a cover 238, hooks 242, feet 270, handles 274, and box latches 294, corresponding with the container 28, the bottom surface 30, the top surface 32, the side surfaces 34, the housing 36, the cover 38, the hooks 42, the feet 70, the handles 74, and the box latches 94 of the storage box 26, respectively.

Each of the hooks 242 of the second storage box 226 are positioned along the bottom surface 230 of the container 228 and individually disposed adjacent a corner of the container 228 (e.g., four corners of the container 28 configured as a rectangular prism). The box latches 94 of the storage box 26 are positioned relative to one another along the top surface 32 in a configuration that mirrors the positioning of the hooks 242 along the bottom surface 230 of the container 228 of the second storage box 226. As such, the hooks 242 are individually aligned with the box latches 94 when the second storage box 226 is properly positioned on the top surface 32 of the storage box 26. When the second storage box 226 is properly positioned on the top surface 32 of the storage box 26, each of the hooks 42 of the second storage box 226 are rotated from the stowed position to the locked position. The hooks 242 of the second storage box 226 individually engage the box latches 94 of the storage box 26 to mount the second storage box 226 to the storage box 26. It is to be appreciated that the storage box 26 system 22 may further include additional (infinite) storage boxes that be stacked upon, and mounted to, one another.

The operation of assembling the storage box 26 to the vehicle 20 by engaging the hooks 42 with the latches 40 will now be described in detail and with reference to the Figures.

With the handles 74 of the storage box 26 in the first position and the hooks 42 of the storage box 26 in the stowed position (as shown in FIG. 3), the user positions the storage box 26 on the floor surface 24 and aligns each of the hooks 42 individually with each of the latches 40. The user grasps and moves one of the handles 74 from the first position (FIG. 6) to the second position (FIG. 7). The movement of the handle 74 from the first position to the second position causes movement of the transmission assembly 75 corresponding with the handle 74. The movement of the transmission assembly 75 causes rotation of the hook 42 corresponding with the handle 74 from the stowed position to the locked position. As the hook 42 rotates from the stowed position to the locked position (as shown between FIGS. 8-10), the latch 40 moves into the channel 44 of the hook 42 and along the cam surface 56 from the first end 64 to the second end 66, which places the hook 42 in the locked position and the storage box 26 in the engaged position. The user then repeats the process for each of the handles 74 that are the first position and the hooks 42 that correspond with the handles 74 and are disposed in the stowed position (i.e., the three handles 74 remaining in the first position and the three hooks 42 remaining that are in the stowed position). After all of the hooks 42 have been moved to the locked position, the storage box 26 is mounted to the vehicle 20.

The operation of disassembling the storage box 26 from the vehicle 20 by disengaging the hooks 42 from the latches 40 will now be described in detail and with reference to the Figures.

With the handles 74 of the storage box 26 in the second position and the hooks 42 of the storage box 26 in the locked position (as shown in FIG. 4), the user grasps and moves one of the handles 74 from the second position (FIG. 7) to the first position (FIG. 6). The movement of the handle 74 from the second position to the first position causes movement of the transmission assembly 75 corresponding with the handle 74. The movement of the transmission assembly 75 causes rotation of the hook 42 corresponding with the handle 74 from the locked position to the stowed position. As the hook 42 rotates from the locked position to the stowed position (as shown in reverse order between FIGS. 8-10), the latch 40 moves through the channel 44 of the hook 42 and along the cam surface 56 from the second end 66 to the first end 64. The hook 42 continues to rotate, moving the latch 40 off of the cam surface 56 and out of the channel 44 of the hook 42, which disengages the hook 42 from the latch 40 and places the hook 42 in the stowed position and the storage box 26 in the disengaged position. The user then repeats the process for each of the handles 74 that are in the second position and the hooks 42 that correspond with the handles 74 and are disposed in the locked position (i.e., the three handles 74 remaining in the second position and the three hooks 42 remaining that are in the locked position). After all of the hooks 42 have been moved to the stowed position, the storage box 26 is disengaged from the vehicle 20 and may be moved independent of the vehicle 20.

It should now be understood that embodiments of the present disclosure are directed to a storage box system for a vehicle. The storage box system may include a floor surface, a latch disposed adjacent the floor surface and configured to be mounted to the vehicle. The storage box system may further include a storage box. The storage box may include a container having a bottom surface facing the floor surface and a hook mounted to the container adjacent the bottom surface and defining a channel that engages the latch to couple the container to the vehicle. The hook is rotatable between a stowed position in which the hook is at least flush with the bottom surface of the container and a locked position in which the hook protrudes from the bottom surface and engages the latch. The engagement of the hook of the storage box with the latch in the locked position secures the storage box relative to the vehicle. Furthermore, the movement of the hook to the stowed position allows the storage box to be removed for the vehicle when its use is not necessary within the vehicle, freeing up space within the vehicle that may be occupied by other people, objects, etc.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A storage box for coupling with a latch mounted to a vehicle, the storage box comprising:
a container having a bottom surface configured to face a floor surface of the vehicle; and
a hook mounted to the container adjacent the bottom surface and defining a channel configured to engage the latch to couple the container to the vehicle, the hook rotatable between a stowed position in which the hook is at least flush with the bottom surface of the container and a locked position in which the hook protrudes from the bottom surface for engaging the latch.

2. The storage box of claim 1, wherein the hook includes a cam surface partially defining the channel and facing the bottom surface of the container in the locked position, the cam surface configured to engage the latch disposed in the channel in the locked position.

3. The storage box of claim 2, wherein the cam surface has an arcuate configuration.

4. The storage box of claim 2, wherein the hook is rotatable about an axis and the cam surface extends between a first end spaced a first distance from the axis and a second end spaced a second distance from the axis and less than the first distance, the hook configured to move the cam surface along the latch from the first end toward the second end as the hook rotates from the stowed position to the locked position and correspondingly move the container toward the floor surface.

5. The storage box of claim 4, wherein the hook includes a detent extending into the channel from the cam surface between the first end and the second end for inhibiting movement of hook from the locked position to the stowed position when the cam surface engages the latch.

6. The storage box of claim 5, further comprising a foot disposed along and extending away from the bottom surface and configured to engage the floor surface of the vehicle, the foot configured to exert a bias between the container and the floor surface as the container moves toward the floor surface when the hook moves from the stowed position to the locked position and engages the latch.

7. The storage box of claim 6, wherein the foot is comprised of an elastomer.

8. The storage box of claim 1, wherein the channel opens toward the bottom surface of the container in the locked position to retain the latch therein.

9. The storage box of claim 1, wherein the container defines a cavity that extends inwardly from the bottom surface, the hook mounted to the container within the cavity.

10. The storage box of claim 9, wherein the hook is entirely disposed within the cavity in the stowed position.

11. The storage box of claim 1, further comprising a handle coupled to the hook and movable between a first position and a second position that drives rotation of the hook between the stowed position and the locked position, respectively.

12. The storage box of claim 1, further comprising a box latch mounted to the container adjacent a top surface, opposite the bottom surface, and configured to couple a second storage box thereto.

13. A storage box system for a vehicle, the storage box system comprising:
a floor surface;
a latch disposed adjacent the floor surface and configured to be mounted to the vehicle; and
a storage box comprising:
a container having a bottom surface facing the floor surface; and
a hook mounted to the container adjacent the bottom surface and defining a channel that engages the latch to couple the container to the vehicle, the hook rotatable between a stowed position in which the hook is at least flush with the bottom surface of the container and a locked position in which the hook protrudes from the bottom surface and engages the latch.

14. The storage box system of claim 13, wherein the floor surface defines an aperture and the latch is aligned with the aperture and disposed beneath the floor surface.

15. The storage box system of claim 13, wherein the latch extends horizontally and has a substantially cylindrical configuration.

16. The storage box system of claim 15, wherein the latch has a diameter and the channel has a minimum width, the minimum width being greater than or equal to the diameter.

17. The storage box system of claim 13, wherein the hook includes a cam surface partially defining the channel and facing the bottom surface of the container in the locked position, the cam surface engaging the latch disposed in the channel in the locked position.

18. The storage box system of claim 17, wherein the hook is rotatable about an axis and the cam surface extends between a first end spaced a first distance from the axis and a second end spaced a second distance from the axis and less than the first distance, the cam surface of the hook moving along the latch from the first end toward the second end as the hook rotates from the stowed position to the locked position and correspondingly moving the container toward the floor surface.

19. The storage box system of claim 18, further comprising a foot disposed along and extending away from the bottom surface of the container and engaging the floor surface, the foot exerting a bias between the container and the floor surface as the container moves toward the floor surface when the hook moves from the stowed position to the locked position and engages the latch.

20. A storage box for coupling with a latch mounted to a vehicle, the storage box comprising:
a container having a bottom surface configured to face a floor surface of the vehicle;
a hook mounted to the container adjacent the bottom surface and defining a channel configured to engage the latch to couple the container to the vehicle, the hook rotatable about an axis between a stowed position in which the hook is at least flush with the bottom surface of the container and a locked position in which the hook protrudes from the bottom surface for engaging the latch, the hook comprising:
a cam surface partially defining the channel and facing the bottom surface of the container in the locked position, the cam surface configured to engage the latch disposed in the channel in the locked position,
wherein the cam surface has an arcuate configuration and extends between a first end spaced a first distance from the axis and a second end spaced a second distance from the axis and less than the first distance, the hook configured to move the cam surface along the latch from the first end toward the second end as the hook rotates from the stowed position to the locked position and correspondingly move the container toward the floor surface;
a handle coupled to the hook and movable between a first position and a second position that drives rotation of the hook between the stowed position and the locked position, respectively; and
a box latch mounted to the container adjacent a top surface, opposite the bottom surface, and configured to couple a second storage box thereto.
